(19) United States
(12) Patent Application Publication
(10) Pub. No.: US 2025/0093563 A1
(43) Pub. Date: Mar. 20, 2025

(54) ANGULAR OCCLUSION FILTER

(71) Applicant: Meta Platforms Technologies, LLC, Menlo Park, CA (US)

(72) Inventors: Zhimin Shi, Bellevue, WA (US); Zhaoyu Nie, Redmond, WA (US); Sheng Ye, Redmond, WA (US); Arman Boromand, Issaquah, WA (US); Xiayu Feng, Kirkland, WA (US); Andrew John Ouderkirk, Kirkland, WA (US)

(21) Appl. No.: 18/732,070

(22) Filed: Jun. 3, 2024

Related U.S. Application Data
(60) Provisional application No. 63/583,774, filed on Sep. 19, 2023.

(51) Int. Cl. G02B 5/30

(52) U.S. Cl. CPC G02B 5/3016

(57) ABSTRACT

An optical element includes a display device and an angular occlusion filter disposed over at least one surface of the display device. The angular occlusion filter may be configured to modulate one or more of transmission, reflection, and polarization of image or ambient light incident upon the display device.

### CROSS-REFERENCE TO RELATED APPLICATION

This application claims the benefit of priority under 35 U.S.C. § 119(e) of U.S. Provisional Application No. 63/583,774, filed Sep. 19, 2023, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an isometric view of an angular occlusion filter according to some embodiments.

FIG. 2 shows a permittivity tensor and conditions for identifying thin film materials suitable for forming an angular occlusion filter according to various embodiments.

FIG. 3 is a cross-sectional view of an example multilayer angular occlusion module according to some embodiments.

FIG. 4 is a cross-sectional view of an example multilayer angular occlusion module according to some embodiments.

FIG. 5 is a cross-sectional view of an example multilayer angular occlusion module according to further embodiments.

FIG. 6 is a cross-sectional view of an example multilayer angular occlusion module according to still further embodiments.

FIG. 7 is a schematic view of exemplary high refractive index moieties for forming thin films within a multilayer angular occlusion filter according to some embodiments.

FIG. 8 depicts example high refractive index molecules for forming an angular occlusion filter according to some embodiments.

FIG. 9 depicts example high refractive index structures for forming an angular occlusion filter according to some embodiments.

FIG. 10 depicts example high refractive index structures for forming an angular occlusion filter according to further embodiments.

FIG. 11 depicts liquid crystal molecules for forming an angular occlusion filter according to some embodiments.

FIG. 12 is a plot of reflectivity versus incidence angle for light incident upon an example angular occlusion filter according to some embodiments.

FIG. 13 shows simplified architectures of optical elements having a co-integrated user-side angular occlusion filter according to some embodiments.

FIG. 14 shows simplified architectures of optical elements having a co-integrated world-side angular occlusion filter according to some embodiments.

FIG. 15 is an illustration of exemplary augmented-reality glasses that may be used in connection with embodiments of this disclosure.

FIG. 16 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Virtual reality and augmented reality devices and headsets typically include an optical system having a microdisplay and imaging optics for each eye. The microdisplay is configured to provide an image to be viewed either directly or indirectly using, for example, a micro OLED display or by illuminating a liquid-crystal based display. Display light may be projected to the eyes of a user using a waveguide where the light is in-coupled into the waveguide, transported therethrough by total internal reflection (TIR), and out-coupled through out-couplers when reaching the position of a viewer's eye. Within the waveguide, image light may interact with intermediate functional modules, including beam splitters, folded gratings, etc.

In some systems, the imaging optics may include a geometric waveguide. With a geometric waveguide, light from the optical engine is in-coupled typically through a reflective mirror or prism, and then transported by TIR to an array of transflective surfaces that are configured to reflect a portion of the light to the eye of a user and transmit a remaining portion of the light for further propagation. Transmitted light may encounter another transflective surface where the reflection and transmission paradigm is repeated.

The present disclosure relates generally to optical elements for modifying one or more properties of light incident on an augmented reality device or headset, and more specifically to an angular occlusion filter (AOF) configured to modulate one or more of transmission, reflection, and polarization of image or ambient light. In certain embodiments, an angular occlusion filter may include a combination of functional modules. In certain embodiments, an optical element such as a head-mounted display may include one or more angular occlusion filters (AOFs).

Due to design or manufacturing issues, the optical components in a head mounted display system can interact with light from the display engine and/or from the environment in an unintended way, which may lead to a negative user experience. In some cases, ambient light interacting with the coupling/folding gratings in a waveguide component, for example, can form bright and colored spots within the main field of view (FOV) of the augmented reality content that overlay or interfere with the content viewed by a user. In a further example, residual reflections from curved or slanted surfaces of the display can create ghost imagery of the display content or the world view at unintended locations. A system level rainbow reduction solution can open the waveguide design space and enable commercially-relevant display system architectures.

Notwithstanding recent developments, it would be advantageous to make available an integrated filter configured to provide wavelength, polarization, and angularly selective reflection/transmission that can mitigate these and other effects. An angular occlusion filter (AOF) may be configured as a thin film stack and may be located on the user side or the world side of the viewing optics of an augmented reality display. For instance, an AOF can cover the entire viewing area (e.g., lens) of a head-mounted display system. Alternatively, an AOF can partially cover the viewing area, which can be equal to or larger than the area where unwanted display interactions are stronger than a pre-determined threshold. An example strong interaction region may include the output coupler of an AR waveguide.

According to some embodiments, an AOF may be adapted to reflect a particular polarization of light (e.g., p-polarized light) having a large incidence angle (e.g., greater than approximately 35 degrees) and transmit that polarization of light for a small incidence angle (e.g., normal incidence) or having the orthogonal polarization (e.g., s-polarized light). According to further embodiments, an AOF may be configured to reflect a particular polarization of light (e.g., p-polarized light) having a large incidence angle (e.g., greater than approximately 70 degrees), transmit that polarization of light for a small incidence angle (e.g., less than approximately 35 degree) and provide partial transmission/partial reflection of that polarization of light for intermediate incidence angles.

As disclosed herein, an AOF may include a multilayer stack of optical thin films. Functional multilayer stacks, including an anti-reflection module, a polarization adjustment module, and an angular occlusion module may be co-integrated to form an angular occlusion filter (AOF). For the multiple thin films constituting each module, the individual thin film properties may be independently tailored. Example thin film properties include composition and thickness, and design criteria for a given multilayer may further include the stacking sequence of the thin films. As used herein, the term “thin film” may, in various embodiments, refer to a layer of material ranging in thickness from a few nanometers to a several micrometers.

According to particular embodiments, an angular occlusion filter (AOF) includes an angular occlusion module. An angular occlusion filter (AOF) having an angular occlusion module may additionally include one or more anti-reflection modules and/or one or more polarization adjustment modules. An angular occlusion filter (AOF) may be configured to provide high transmission across a predetermined transparency region (e.g., as a function of angular, wavelength, and polarization space) while providing high reflection across a predetermined occlusion region.

As disclosed herein, an angular occlusion module may be configured to have high transmission of light of certain wavelengths and/or polarization for small incidence angles (e.g., normal incidence), and high reflection of light when the angle of incidence is large.

In a multilayer angular occlusion module, each layer may be compositionally homogeneous or non-homogeneous and may include one or more materials, such as a polymer, dielectric, metal, semiconductor, organic single crystal, etc. Each layer may be characterized as optically isotropic, uni-axial, or bi-axial. Further example layers forming a multilayer angular occlusion module may include nanocomposite materials, such as a liquid crystal stabilized in a polymer host, or a meta-material.

As disclosed herein, a polarization adjustment module may be configured to change the polarization state of light that traverses the interface between the module and adjacent media, such as air or other optical elements. A polarization adjustment module may include a multilayer thin film stack where each thin film layer may include one or more materials, such as a polymer, dielectric, metal, semiconductor, organic single crystal, etc. Each layer may be characterized as optically isotropic, uni-axial, or bi-axial. Further example layers forming a multilayer polarization adjustment module may include nanocomposite materials, such as a liquid crystal stabilized in a polymer host, or a meta-material.

As disclosed herein, an anti-reflection module may be configured to decrease the reflection of light that traverses the module. An anti-reflection module may include a multilayer thin film stack where each thin film layer may include one or more materials, such as a polymer, dielectric, metal, semiconductor, organic single crystal, etc. Each layer may be characterized as optically isotropic, uni-axial, or bi-axial. Further example layers forming a multilayer anti-reflection module may include nanocomposite materials, such as a liquid crystal stabilized in a polymer host, or a meta-material.

Each layer within a multilayer stack may be laminated, evaporated, deposited, sprayed, or fabricated through any suitable micro or nano-fabrication process (e.g., photolithography, nano-imprint lithography, etc.). A multilayer (e.g., an angular occlusion module, an anti-reflection module, or a polarization adjustment module) may be manufactured through the successive formation of each respective layer. Example multilayer thin film processes include hot melt co-extrusion and multilayer hot pressing.

In a hot melt co-extrusion process, distinct polymers or polymer mixtures may be passed through a feedblock and/or multiplier to form multilayers, followed by orientation at around or above the polymer's glass transition temperature. An electric field or magnetic field may be applied prior to or during solidification of the melt. A post curing process may be applied to the oriented film stack. An electric or magnetic field may be applied during the post curing process.

In a dual material multilayer hot press process, an A layer thin film and a B layer thin film may be formed separately. Alternating ABAB layers may be stacked and pressed at or above the polymers' glass transition temperature to achieve a targeted thickness. In a multi-material multilayer hot press process, different polymer layers may be formed separately, stacked in a desired sequence, and pressed to achieve a targeted thickness. An electric or magnetic field may be applied during each thin film forming step or during the multilayer press. An additional orientation step may be applied to the film stack.

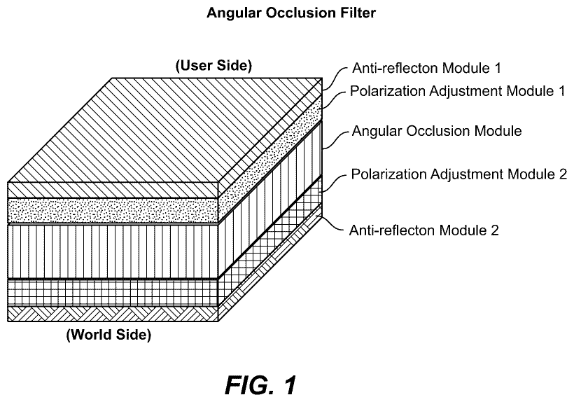

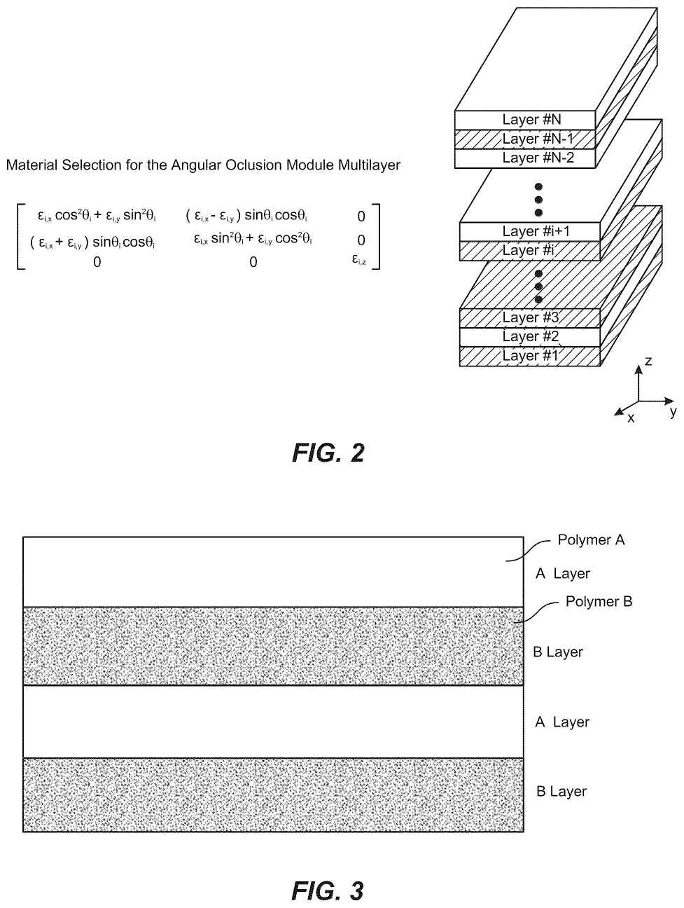

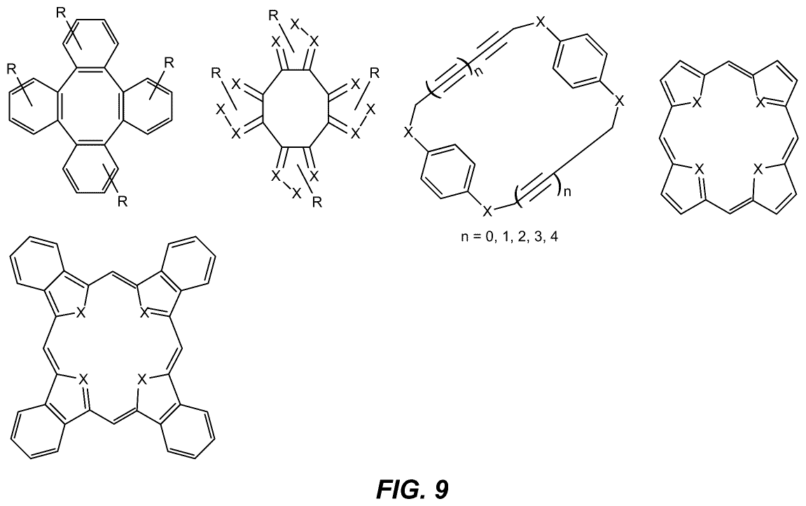

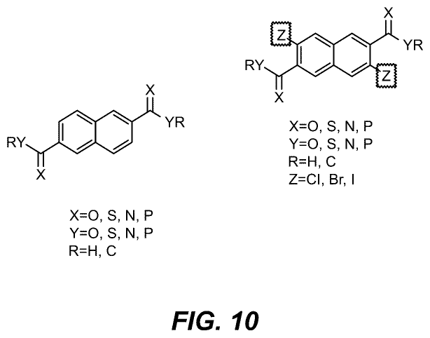

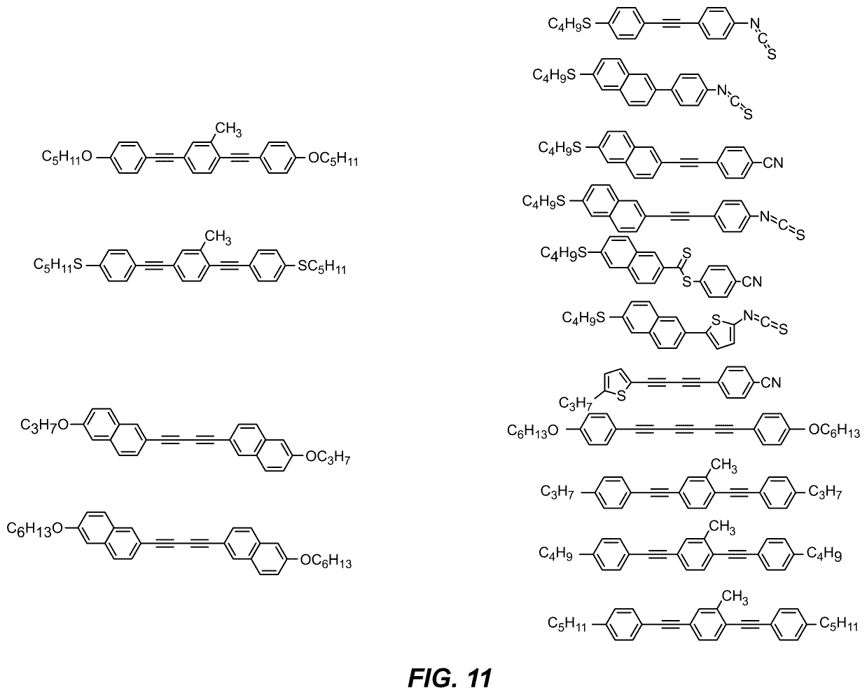

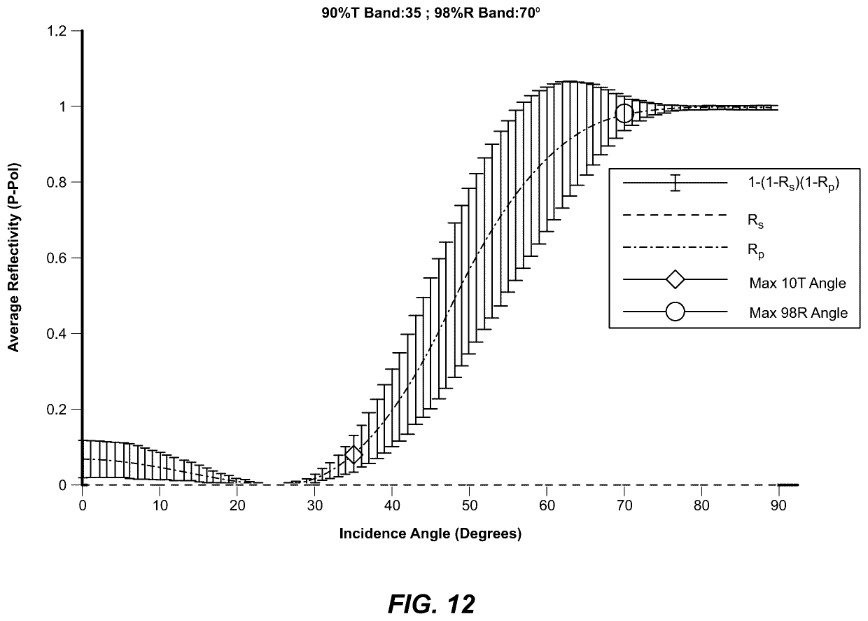

The following will provide, with reference to FIGS. 1-16, detailed descriptions of devices and related methods associated with an angular occlusion filter. The discussion associated with FIG. 1 includes a description of an example angular occlusion filter architecture. The discussion associated with FIG. 2 includes a description of selection criteria for forming an angular occlusion module. The discussion associated with FIGS. 3-6 relates to the structure of a multilayer angular occlusion module. The discussion associated with FIGS. 7-11 relates to example polymer thin film precursors and additives. The discussion associated with FIG. 12 includes a description of the performance of an example angular occlusion filter.

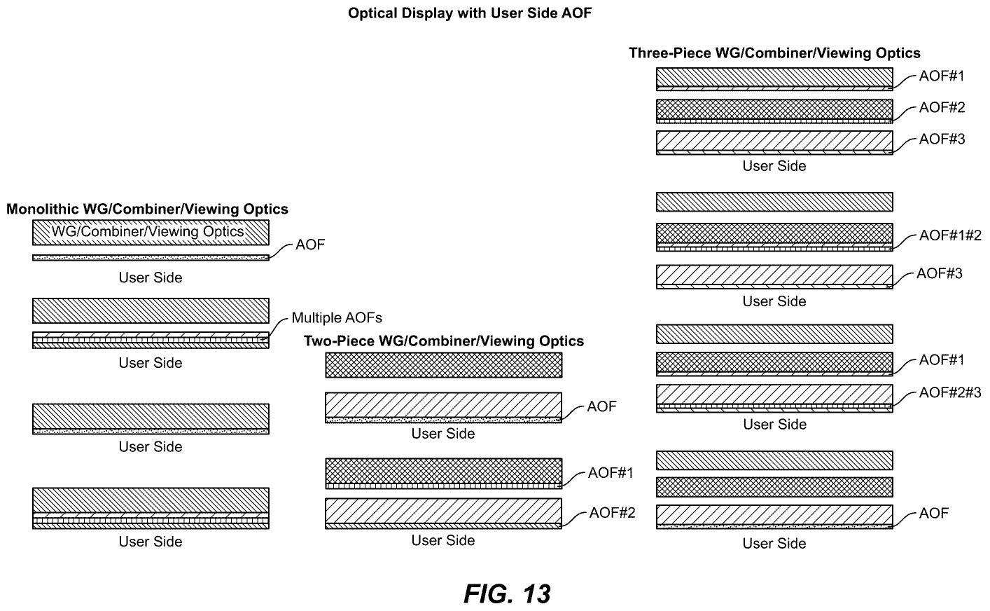

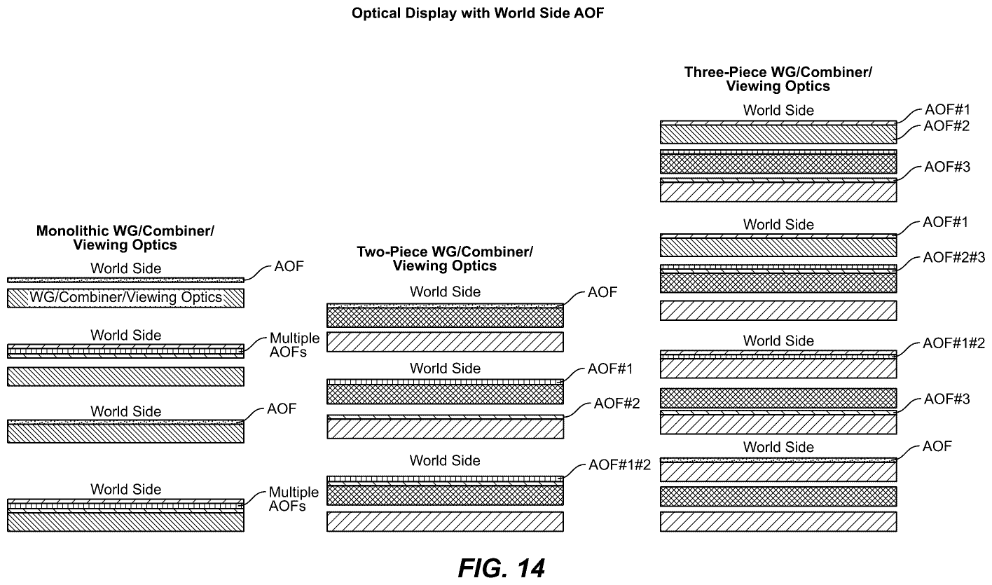

The discussion associated with FIGS. 13 and 14 includes a description of the structure and co-integration of an example angular occlusion filter with an optical device such as an AR headset. In various embodiments, one or more angular occlusion filters may be added to one or both of the user side or the world side of a display. Each angular occlusion filter may be directly laminated to a waveguide, combiner, or viewing optics, for example, or to an intervening element, and may be configured to cover a portion, substantially all, or the entire area of the waveguide, combiner, or viewing optics. Multiple angular occlusion filters may be stacked in any configuration and may be designed for operation with all or a subset of the visible spectrum. In an optical system, an angular occlusion filter may be provided for operation within a selected color band.

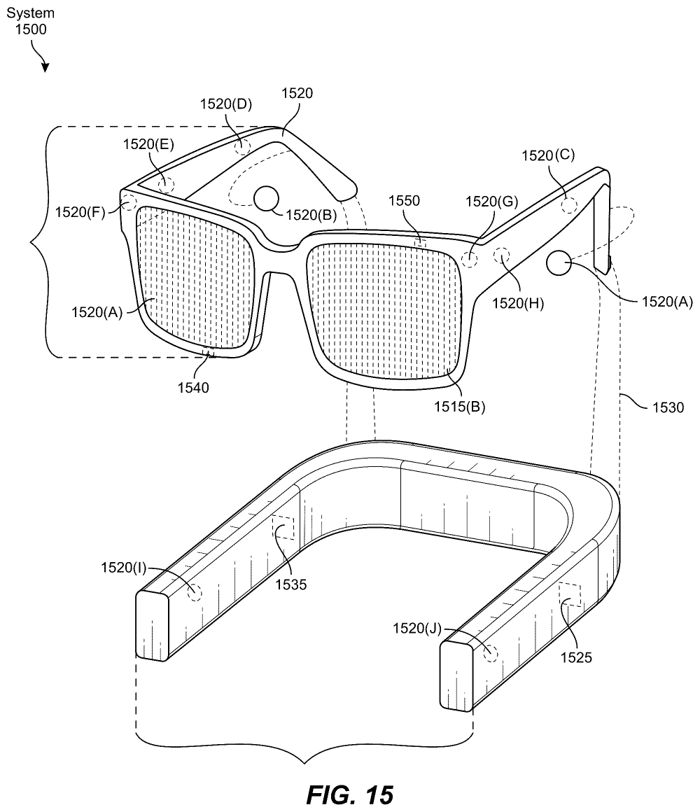

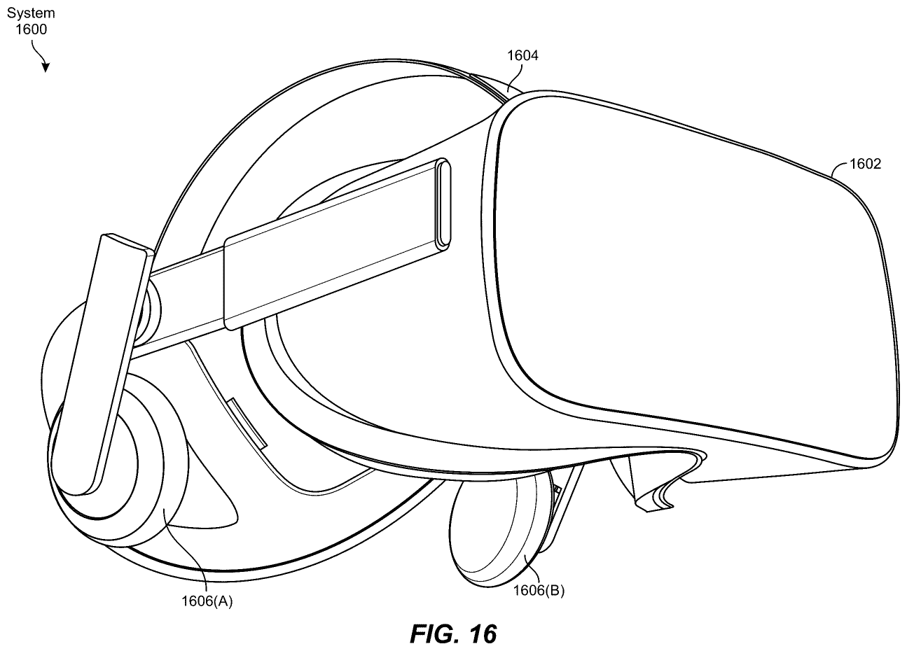

The discussion associated with FIGS. 15 and 16 relates to exemplary virtual reality and augmented reality devices that may include one or more angular occlusion filters as disclosed herein.

Referring to FIG. 1, an angular occlusion filter may include two or more functional modules. For instance, the angular occlusion filter may include an angular occlusion module. The angular occlusion module may be configured to provide angularly selective reflection or transmission of light incident upon the occlusion filter. The angular occlusion filter may additionally include one or more of a polarization adjustment module and an anti-reflection module. A polarization adjustment module, if provided, may provide particular polarization state manipulation functions. An anti-reflection module, if provided, may be configured to decrease reflection of light traversing the interface between the angular occlusion filter and adjacent media, such as air or other optical elements.

Referring still to FIG. 1, a polarization adjustment module disposed over the user side of the angular occlusion module (e.g., polarization adjustment module 1) may be configured to improve compatibility between the angular occlusion module and a specific waveguide/combiner architecture. A polarization adjustment module disposed over the world side of the angular occlusion module (e.g., polarization adjustment module 2) may be configured to influence what portion of the world view is filtered by the angular occlusion module.

Referring to FIG. 2, disclosed are exemplary materials selection criteria for manufacturing the thin film layers within a multilayer angular occlusion module. For an angular occlusion module including N (N>3) material layers, the optical (or effective optical) properties of the i-th layer can be described using the illustrated tensor, where (ε_{i,x}, ε_{i,y}, ε_{i,z}) are the dielectric susceptibility (or effective dielectric susceptibility) of the i-th layer material along its three optical axes, and θᵢ is the angle between the i-th layer material optical x-axis and a specific global in-plane x-axis of the thin film. It is assumed that the z-axis of the material aligns with the out-of-plane direction of the film. For any neighboring i-th and (i+1)-th layers, the material optical properties may satisfy one or more of the following conditions A-E.
A. |ε_{i,x} cos² θᵢ+ε_{j,y} sin² θᵢ−(ε_{i+1,x} cos² θᵢ₊₁ +ε_{i+1,y} sin² θᵢ₊₁)|<0.1;
B. |(ε_{i,x}−ε_{j,y}) sin θᵢ cosθᵢ−(ε_{i+1,x}−ε_{i+1,y}) sin θᵢ₊₁ cos θᵢ₊₁|<0.1;
C. |ε_{j,x} sin² θᵢ+ε_{j,y} cos² θᵢ−(ε_{i+1,x} sin² θᵢ₊₁+ε_{i+1,y} cos² θᵢ₊₁)|<0.1;
D. |(ε_{j,z}−ε_{i+1,z})|>0.05; and
E. |n_{i,x}−n_{i,y}|<0.05, where n_{i,x}≡\sqrt{ε_{i,x}}, n_{i,y}≡\sqrt{ε_{i,y}}.

Without wishing to be bound by theory and in accordance with further embodiments, each of criteria A-C may be alternately represented by an upper limit of 0.05 (in lieu of 0.1) and criterion E may be alternately represented by an upper limit of 0.02 (in lieu of 0.05).

Example angular occlusion module architectures are shown in FIGS. 3-6. The illustrated structures each include a stacked configuration of alternating A and B layers. Optionally, the A layers may include an A polymer and the B layers may include a B polymer where the A and B polymer layers may independently include an oriented or random distribution of a second phase, such as inorganic particles or particles of an organic or liquid crystal material having a desired composition, size, size distribution, shape, loading, etc. Such particles may be characterized as inclusions.

Applicants have developed a number of approaches for manufacturing high average refractive index (n>1.6) polymer layers having a small in-plane birefringence. In some embodiments, a high refractive index atom may be incorporated into the polymer backbone or polymer side chain. Example high refractive index atoms include N, O, S, Cl, and Br. Such a polymer material may be oriented uniaxially or biaxially through a suitable stretching process.

According to further embodiments, high average refractive index polymer materials may include a high refractive index (e.g., n>2) organic additive, such as particles, needles, or nanoscale crystals. Such a modified polymer material may be oriented uniaxially or biaxially through a suitable stretching process.

According to still further embodiments, in a multilayer architecture, one of the polymer layers may be formed from or include a liquid crystal, organic crystal, or liquid crystal polymer. The liquid crystal, organic crystal, or liquid crystal polymer may be characterized by n_{z}>nₓ and n_{z}>n_{y}.

Referring to FIG. 3, a multilayer angular occlusion module includes an ABAB stacked architecture of A and B polymers. Each polymer layer may include a composition made up of a single phase. In one embodiment, each A layer may include an optically anisotropic high index polymer (nₓ>>n_{z} and n_{y}>>n_{z}), and each B layer may include an optically isotropic high index polymer (n>1.6). In a further embodiment, each A layer may include an optically anisotropic high index polymer (n_{z}>nₓ and n_{z}>n_{y}), and each B layer may include an optically isotropic low index polymer (n<1.6).

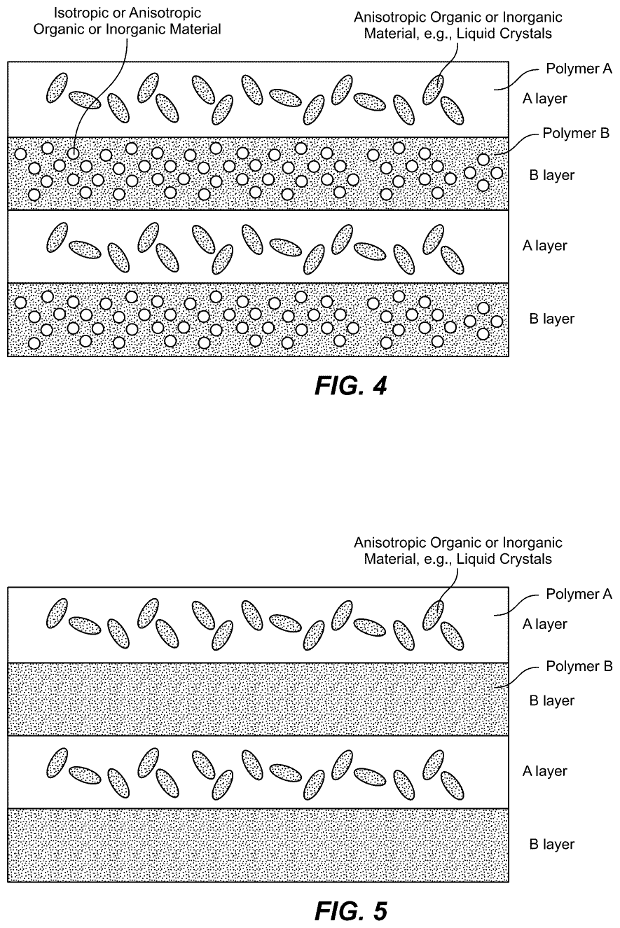

Referring to FIG. 4, a multilayer angular occlusion module includes an ABAB stacked architecture of A and B polymers where the A layer includes embedded particles of an oriented second phase and the B layers include embedded particles of an unoriented second phase. The second phase particles may include an organic or inorganic crystalline material, such as a liquid crystal material. The polymer layers and embedded particles in the A layer may be configured such that n_{A,x}>n_{A,y}>n_{A,z} (i.e., the out-of-plane index is less than the in-plane indices), whereas second phase particles embedded in the B layer may be randomly dispersed such that the B layer is optically isotropic. In particular embodiments, 0.002<n_{A,x}−N_{A,y}<0.03, n_{A,y}=n_{B}, and n_{A,z}<<n_{B}. Second phase particles may be characterized as inclusions.

Referring to FIG. 5, a multilayer angular occlusion module includes an ABAB stacked architecture of A and B polymers where the A layers include embedded particles of an oriented second phase. The anisotropic particles in the A layer may be aligned by an applied electric or magnetic field prior to cross-linking and/or polymerization of the A polymer. The polymer layers and embedded particles may be configured such that nₓ<n_{z} and n_{y}<n_{z} for the A layers, (i.e., the out-of-plane index is greater than the in-plane indices). In particular embodiments, n_{A,z}>n_{A,x}>n_{A,y}, 0.002<n_{A,x}−n_{A,y}<0.03, n_{A,y}=n_{B}, and n_{A,z}>n_{B}. In some embodiments, within the A layers, the oriented particles may be configured such that nₓ<n_{z} and n_{y}<n_{z} for the particles themselves. Second phase particles may be characterized as inclusions.

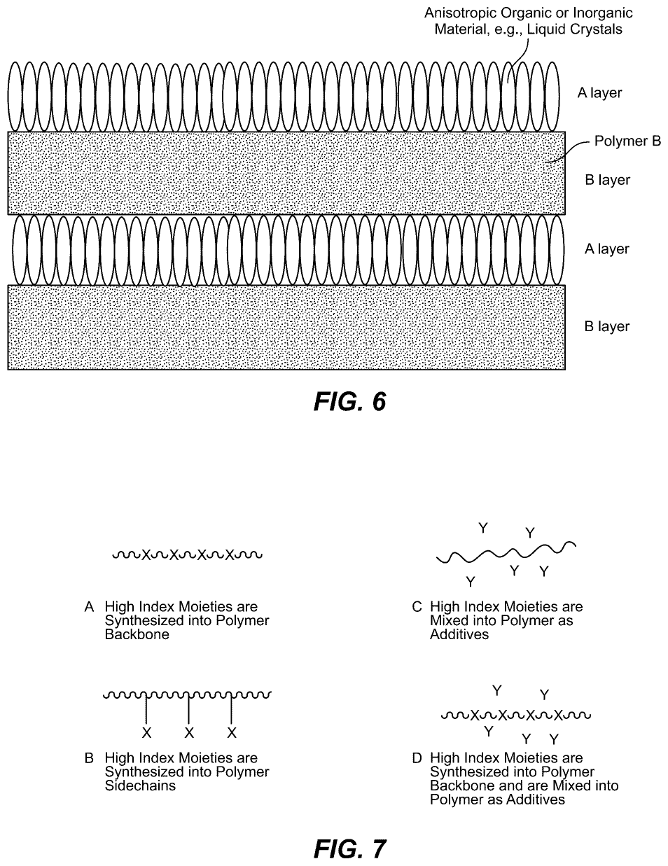

The multilayer angular occlusion module architecture shown in FIG. 6 includes optically anisotropic A layers of oriented organic or liquid crystal material and optically isotropic B layers of a suitable optical polymer. The oriented crystals and the polymer layers may be configured such that nₓ<n_{z} and n_{y}<n_{z} for the A layers with n_{A,y}=n_{B} and n_{A,z}>>n_{B}. In particular embodiments, n_{A,z}>n_{A,x}>n_{A,y}, 0.002<n_{A,x}−n_{A,y}<0.03, n_{A,y}=n_{B}, and n_{A,z}>>n_{B}. An applied electric or magnetic field may be used to orient the organic or liquid crystal material of the A layers.

Referring to FIG. 7, depicted are example high refractive index moieties that may be used to form the one or more polymer layers constituting a multilayer angular occlusion filter. The illustrated structures can be synthesized into polymer chains as backbones (FIG. 7A), side chains (FIG. 7B), or as an additive withing a polymer mixture (FIG. 7C and FIG. 7D). As additives, example high index moieties may constitute approximately 5 to 80 vol. % of a polymer mixture and hence approximately 5 to 80 vol. % of a resulting polymer thin film.

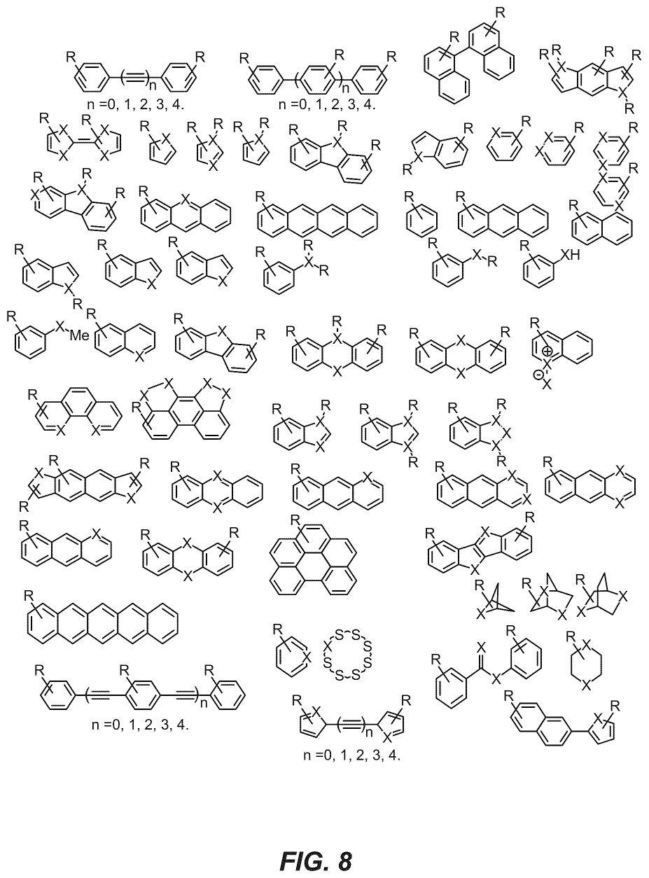

Referring to FIGS. 8-10, shown are example small molecules suitable for forming one or more polymer layers within an angular occlusion filter. These and other molecules may be polymerized and formed into a thin film or incorporated into a polymer thin film as an additive. A polymer melt, for instance, may include from approximately 5 to 80 wt. % of an additive. During an act of stretching a polymer thin film formed from such a melt, an additive may form oriented crystals within the thin film, as depicted in FIGS. 4 and 5. An additive may be incorporated into one or both of the A layer and the B layer of a multilayer structure. Amongst A and B layers, the additive composition and content may be the same or different.

According to further embodiments, the molecules shown in FIG. 8-10 may form an organic crystallite layer that may be disposed and oriented between polymer layers in a multilayer angular occlusion filter, such as the B layers in FIGS. 3-6. For the molecular structures of FIG. 8, X═C, O, N, S, Se, Te, As, P; and R═H, F, Cl, Br, I, Ph, NO₂, SO₃, SO₂Me, acetyl, carboxyl, aldehyde, SO₂NH₃, linear alkyl, branched alkyl, cyclic alkyl groups, aryl groups, heterocycles, CN, NCS.

Referring to FIG. 11, shown are example liquid crystal structures that may be incorporated into an angular occlusion filter according to certain embodiments. Exemplary liquid crystals may form a strong dipole moment in response to an applied electric or magnetic field and may be mixed with low viscosity reactive monomers, such as acrylates, methacrylates, epoxies, and thiol-enes. A polymer layer may include from approximately 20 to 95 wt. % of a liquid crystal additive. The application of an electric or magnetic field may align liquid crystals within a polymer thin film. In certain embodiments, a high refractive index direction of the liquid crystals may be oriented out of plane, and polymerization and/or cross-linking of the polymer matrix, e.g., via exposure to light, heat, or a suitable catalyst, may be effective to stabilize the desired crystal orientation as shown, for example, in the A layer of FIG. 6.

FIG. 12 is a plot of average reflectivity versus incidence angle across the visible spectrum (400 nm-700 nm) for an angular occlusion module having an alternating ABAB structure with 300 total layers. The optical index of the two materials are n_{A}=1.4; n_{B}≈[1.9, 1.9, 1.4]. This example shows a 90% average transparency window for incidence angles from zero to approximately 35 degrees, and a 98% average reflection window for incidence angles larger than approximately 70 degrees.

FIG. 13 and FIG. 14 show example optical elements having one or more co-integrated user-side angular occlusion filters and one or more co-integrated world-side angular occlusion filters, respectively.

### Example Embodiments

Example 1: An angular occlusion filter includes a multilayer stack having alternating first and second polymer layers, where the first polymer layers include an optically anisotropic polymer material and the second polymer layers include an optically isotropic polymer material.

Example 2: The angular occlusion filter of Example 1, where the first polymer layers include inclusions of an anisotropic second phase.

Example 3: The angular occlusion filter of Example 2, where the anisotropic second phase includes a liquid crystal material.

Example 4: The angular occlusion filter of any of Examples 1-3, where the second polymer layers include inclusions of an isotropic second phase.

Example 5: The angular occlusion filter of any of Examples 1-4, where the first polymer layers have refractive indices n_{A,x}, n_{A,y}, and n_{A,z}, and the second polymer layers have a refractive index n_{B}, such that 0.002<n_{A,x}−n_{A,y}<0.03, n_{A,y}=n_{B}, and n_{A,z}<n_{B}.

Example 6: The angular occlusion filter of any of Examples 1-4, where the first polymer layers have refractive indices n_{A,x}, n_{A,y}, and n_{A,z}, and the second polymer layers have a refractive index n_{B}, such that n_{A,z}>n_{A,x}>n_{A,y}, 0.002<n_{A,x}−n_{A,y}<0.03, n_{A,y}=n_{B}, and n_{A,z}>n_{B}.

Example 7: An angular occlusion filter includes a multilayer stack having alternating first and second layers, where the first layers include an optically anisotropic material and the second layers include an optically isotropic material.

Example 8: The angular occlusion filter of Example 7, where the first layers include an optically anisotropic organic or inorganic material and the second layers include an optically isotropic polymer.

Example 9: The angular occlusion filter of any of Examples 7 and 8, where the first layers include a liquid crystal material and the second layers include an optically isotropic polymer.

Example 10: An optical element includes a display device and an angular occlusion filter disposed over at least one surface of the display device.

Example 11: The optical element of Example 10, where the display device includes a waveguide display.

Example 12: The optical element of any of Examples 10 and 11, where the angular occlusion filter includes an angular occlusion module.

Example 13: The optical element of any of Examples 10-12, where the angular occlusion filter includes a multilayer thin film.

Example 14: The optical element of any of Examples 10-13, where the angular occlusion filter includes a multilayer stack of alternating first and second polymer layers.

Example 15: The optical element of any of Examples 10-14, where the angular occlusion filter includes a multilayer stack of alternating first and second polymer layers, the first polymer layers include an optically anisotropic polymer material, and the second polymer layers include an optically isotropic polymer material.

Example 16: The optical element of any of Examples 10-15, where the angular occlusion filter includes an anti-reflection module.

Example 17: The optical element of any of Examples 10-16, where the angular occlusion filter includes a polarization adjustment module.

Example 18: The optical element of any of Examples 10-17, where the angular occlusion filter includes an angular occlusion module, a polarization adjustment module overlying the angular occlusion module, and an anti-reflection module overlying the polarization adjustment module.

Example 19: The optical element of any of Examples 10-18, where the angular occlusion filter is configured to modulate one or more of transmission, reflection, and polarization of image or ambient light incident upon the display device.

Example 20: The optical element of any of Examples 10-19, including two or more angular occlusion filters.

Embodiments of the present disclosure may include or be implemented in conjunction with various artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (e.g., augmented-reality system 1500 in FIG. 15) or that visually immerses a user in an artificial reality (e.g., virtual-reality system 1600 in FIG. 16). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 15, augmented-reality system 1500 may include an eyewear device 1502 with a frame 1510 configured to hold a left display device 1515(A) and a right display device 1515(B) in front of a user's eyes. Display devices 1515(A) and 1515(B) may act together or independently to present an image or series of images to a user. An angular occlusion filter may be disposed over one or both major surfaces of display devices 1515(A) and 1515(B). While augmented-reality system 1500 includes two displays, embodiments of this disclosure may be implemented in augmented-reality systems with a single NED or more than two NEDs.

In some embodiments, augmented-reality system 1500 may include one or more sensors, such as sensor 1540. Sensor 1540 may generate measurement signals in response to motion of augmented-reality system 1500 and may be located on substantially any portion of frame 1510. Sensor 1540 may represent a position sensor, an inertial measurement unit (IMU), a depth camera assembly, a structured light emitter and/or detector, or any combination thereof. In some embodiments, augmented-reality system 1500 may or may not include sensor 1540 or may include more than one sensor. In embodiments in which sensor 1540 includes an IMU, the IMU may generate calibration data based on measurement signals from sensor 1540. Examples of sensor 1540 may include, without limitation, accelerometers, gyroscopes, magnetometers, other suitable types of sensors that detect motion, sensors used for error correction of the IMU, or some combination thereof.

Augmented-reality system 1500 may also include a microphone array with a plurality of acoustic transducers 1520(A)-1520(J), referred to collectively as acoustic transducers 1520. Acoustic transducers 1520 may be transducers that detect air pressure variations induced by sound waves. Each acoustic transducer 1520 may be configured to detect sound and convert the detected sound into an electronic format (e.g., an analog or digital format). The microphone array in FIG. 15 may include, for example, ten acoustic transducers: 1520(A) and 1520(B), which may be designed to be placed inside a corresponding ear of the user, acoustic transducers 1520(C), 1520(D), 1520(E), 1520(F), 1520(G), and 1520(H), which may be positioned at various locations on frame 1510, and/or acoustic transducers 1520(I) and 1520(J), which may be positioned on a corresponding neckband 1505.

In some embodiments, one or more of acoustic transducers 1520(A)-(F) may be used as output transducers (e.g., speakers). For example, acoustic transducers 1520(A) and/or 1520(B) may be earbuds or any other suitable type of headphone or speaker.

The configuration of acoustic transducers 1520 of the microphone array may vary. While augmented-reality system 1500 is shown in FIG. 15 as having ten acoustic transducers 1520, the number of acoustic transducers 1520 may be greater or less than ten. In some embodiments, using higher numbers of acoustic transducers 1520 may increase the amount of audio information collected and/or the sensitivity and accuracy of the audio information. In contrast, using a lower number of acoustic transducers 1520 may decrease the computing power required by an associated controller 1550 to process the collected audio information. In addition, the position of each acoustic transducer 1520 of the microphone array may vary. For example, the position of an acoustic transducer 1520 may include a defined position on the user, a defined coordinate on frame 1510, an orientation associated with each acoustic transducer 1520, or some combination thereof.

Acoustic transducers 1520(A) and 1520(B) may be positioned on different parts of the user's ear, such as behind the pinna, behind the tragus, and/or within the auricle or fossa. Or, there may be additional acoustic transducers 1520 on or surrounding the ear in addition to acoustic transducers 1520 inside the ear canal. Having an acoustic transducer 1520 positioned next to an ear canal of a user may enable the microphone array to collect information on how sounds arrive at the ear canal. By positioning at least two of acoustic transducers 1520 on either side of a user's head (e.g., as binaural microphones), augmented-reality device 1500 may simulate binaural hearing and capture a 3D stereo sound field around about a user's head. In some embodiments, acoustic transducers 1520(A) and 1520(B) may be connected to augmented-reality system 1500 via a wired connection 1530, and in other embodiments acoustic transducers 1520(A) and 1520(B) may be connected to augmented-reality system 1500 via a wireless connection (e.g., a Bluetooth connection). In still other embodiments, acoustic transducers 1520(A) and 1520(B) may not be used at all in conjunction with augmented-reality system 1500.

Acoustic transducers 1520 on frame 1510 may be positioned along the length of the temples, across the bridge, above or below display devices 1515(A) and 1515(B), or some combination thereof. Acoustic transducers 1520 may be oriented such that the microphone array is able to detect sounds in a wide range of directions surrounding the user wearing the augmented-reality system 1500. In some embodiments, an optimization process may be performed during manufacturing of augmented-reality system 1500 to determine relative positioning of each acoustic transducer 1520 in the microphone array.

In some examples, augmented-reality system 1500 may include or be connected to an external device (e.g., a paired device), such as neckband 1505. Neckband 1505 generally represents any type or form of paired device. Thus, the following discussion of neckband 1505 may also apply to various other paired devices, such as charging cases, smart watches, smart phones, wrist bands, other wearable devices, hand-held controllers, tablet computers, laptop computers, other external compute devices, etc.

As shown, neckband 1505 may be coupled to eyewear device 1502 via one or more connectors. The connectors may be wired or wireless and may include electrical and/or non-electrical (e.g., structural) components. In some cases, eyewear device 1502 and neckband 1505 may operate independently without any wired or wireless connection between them. While FIG. 15 illustrates the components of eyewear device 1502 and neckband 1505 in example locations on eyewear device 1502 and neckband 1505, the components may be located elsewhere and/or distributed differently on eyewear device 1502 and/or neckband 1505. In some embodiments, the components of eyewear device 1502 and neckband 1505 may be located on one or more additional peripheral devices paired with eyewear device 1502, neckband 1505, or some combination thereof.

Pairing external devices, such as neckband 1505, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1500 may be provided by a paired device or shared between a paired device and an eyewear device, thus reducing the weight, heat profile, and form factor of the eyewear device overall while still retaining desired functionality. For example, neckband 1505 may allow components that would otherwise be included on an eyewear device to be included in neckband 1505 since users may tolerate a heavier weight load on their shoulders than they would tolerate on their heads. Neckband 1505 may also have a larger surface area over which to diffuse and disperse heat to the ambient environment. Thus, neckband 1505 may allow for greater battery and computation capacity than might otherwise have been possible on a stand-alone eyewear device. Since weight carried in neckband 1505 may be less invasive to a user than weight carried in eyewear device 1502, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1505 may be communicatively coupled with eyewear device 1502 and/or to other devices. These other devices may provide certain functions (e.g., tracking, localizing, depth mapping, processing, storage, etc.) to augmented-reality system 1500. In the embodiment of FIG. 15, neckband 1505 may include two acoustic transducers (e.g., 1520(I) and 1520(J)) that are part of the microphone array (or potentially form their own microphone subarray). Neckband 1505 may also include a controller 1525 and a power source 1535.

Acoustic transducers 1520(I) and 1520(J) of neckband 1505 may be configured to detect sound and convert the detected sound into an electronic format (analog or digital). In the embodiment of FIG. 15, acoustic transducers 1520(I) and 1520(J) may be positioned on neckband 1505, thereby increasing the distance between the neckband acoustic transducers 1520(I) and 1520(J) and other acoustic transducers 1520 positioned on eyewear device 1502. In some cases, increasing the distance between acoustic transducers 1520 of the microphone array may improve the accuracy of beamforming performed via the microphone array. For example, if a sound is detected by acoustic transducers 1520(C) and 1520(D) and the distance between acoustic transducers 1520(C) and 1520(D) is greater than, e.g., the distance between acoustic transducers 1520(D) and 1520(E), the determined source location of the detected sound may be more accurate than if the sound had been detected by acoustic transducers 1520(D) and 1520(E).

Controller 1525 of neckband 1505 may process information generated by the sensors on neckband 1505 and/or augmented-reality system 1500. For example, controller 1525 may process information from the microphone array that describes sounds detected by the microphone array. For each detected sound, controller 1525 may perform a direction-of-arrival (DOA) estimation to estimate a direction from which the detected sound arrived at the microphone array. As the microphone array detects sounds, controller 1525 may populate an audio data set with the information. In embodiments in which augmented-reality system 1500 includes an inertial measurement unit, controller 1525 may compute all inertial and spatial calculations from the IMU located on eyewear device 1502. A connector may convey information between augmented-reality system 1500 and neckband 1505 and between augmented-reality system 1500 and controller 1525. The information may be in the form of optical data, electrical data, wireless data, or any other transmittable data form. Moving the processing of information generated by augmented-reality system 1500 to neckband 1505 may reduce weight and heat in eyewear device 1502, making it more comfortable to the user.

Power source 1535 in neckband 1505 may provide power to eyewear device 1502 and/or to neckband 1505. Power source 1535 may include, without limitation, lithium ion batteries, lithium-polymer batteries, primary lithium batteries, alkaline batteries, or any other form of power storage. In some cases, power source 1535 may be a wired power source. Including power source 1535 on neckband 1505 instead of on eyewear device 1502 may help better distribute the weight and heat generated by power source 1535.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1600 in FIG. 16, that mostly or completely covers a user's field of view. Virtual-reality system 1600 may include a front rigid body 1602 and a band 1604 shaped to fit around a user's head. Virtual-reality system 1600 may also include output audio transducers 1606(A) and 1606(B). Furthermore, while not shown in FIG. 16, front rigid body 1602 may include one or more electronic elements, including one or more electronic displays, one or more inertial measurement units (IMUs), one or more tracking emitters or detectors, and/or any other suitable device or system for creating an artificial reality experience.

Artificial-reality systems may include a variety of types of visual feedback mechanisms. For example, display devices in augmented-reality system 1500 and/or virtual-reality system 1600 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some artificial-reality systems may include one or more projection systems. For example, display devices in augmented-reality system 1500 and/or virtual-reality system 1600 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

Artificial-reality systems may also include various types of computer vision components and subsystems. For example, augmented-reality system 1500 and/or virtual-reality system 1600 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real- world surroundings, and/or to perform a variety of other functions.

Artificial-reality systems may also include one or more input and/or output audio transducers. In the examples shown in FIG. 16, output audio transducers 1606(A) and 1606(B) may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

While not shown in FIG. 15, artificial-reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of” are implied. Thus, for example, implied alternative embodiments to a thin film that comprises or includes anthracene include embodiments where a thin film consists essentially of anthracene and embodiments where a thin film consists of anthracene.

What is claimed is:

1. An angular occlusion filter comprising:
a multilayer stack comprising alternating first and second polymer layers, wherein the first polymer layers comprise an optically anisotropic polymer material and the second polymer layers comprise an optically isotropic polymer material.

2. The angular occlusion filter of claim 1, wherein the first polymer layers comprise inclusions of an anisotropic second phase.

3. The angular occlusion filter of claim 2, wherein the anisotropic second phase comprises a liquid crystal material.

4. The angular occlusion filter of claim 1, wherein the second polymer layers comprise inclusions of an isotropic second phase.

5. The angular occlusion filter of claim 1, wherein the first polymer layers have refractive indices n_{A,x}, n_{A,y}, and n_{A,z}, and the second polymer layers have a refractive index n_{B}, such that 0.0002<n_{A,x}−n_{A,y}<0.03, n_{A,y}=n_{B}, and n_{A,z}<n_{B}.

6. The angular occlusion filter of claim 1, wherein the first polymer layers have refractive indices n_{A,x}, n_{A,y}, and n_{A,z}, and the second polymer layers have a refractive index n_{B}, such that n_{A,z}>n_{A,x}>n_{A,y}, 0.002<n_{A,x}−n_{A,y}<0.03, n_{A,y}=n_{B}, and n_{A,z}>n_{B}.

7. An angular occlusion filter comprising:
a multilayer stack comprising alternating first and second layers, wherein the first layers comprise an optically anisotropic material and the second layers comprise an optically isotropic material.

8. The angular occlusion filter of claim 7, wherein the first layers comprise an optically anisotropic organic or inorganic material and the second layers comprise an optically isotropic polymer.

9. The angular occlusion filter of claim 7, wherein the first layers comprise a liquid crystal material and the second layers comprise an optically isotropic polymer.

10. An optical element comprising:
a display device; and
an angular occlusion filter disposed over at least one surface of the display device.

11. The optical element of claim 10, wherein the display device comprises a waveguide display.

12. The optical element of claim 10, wherein the angular occlusion filter comprises an angular occlusion module.

13. The optical element of claim 10, wherein the angular occlusion filter comprises a multilayer thin film.

14. The optical element of claim 10, wherein the angular occlusion filter comprises a multilayer stack of alternating first and second polymer layers.

15. The optical element of claim 10, wherein the angular occlusion filter comprises a multilayer stack of alternating first and second polymer layers, the first polymer layers comprise an optically anisotropic polymer material, and the second polymer layers comprise an optically isotropic polymer material.

16. The optical element of claim 10, wherein the angular occlusion filter comprises an anti-reflection module.

17. The optical element of claim 10, wherein the angular occlusion filter comprises a polarization adjustment module.

18. The optical element of claim 10, wherein the angular occlusion filter comprises an angular occlusion module, a polarization adjustment module overlying the angular occlusion module, and an anti-reflection module overlying the polarization adjustment module.

19. The optical element of claim 10, wherein the angular occlusion filter is configured to modulate one or more of transmission, reflection, and polarization of image or ambient light incident upon the display device.

20. The optical element of claim 10, comprising two or more angular occlusion filters.
